(19) United States
(12) Patent Application Publication
(10) Pub. No.: US 2024/0078482 A1
(43) Pub. Date: Mar. 7, 2024

(54) PROCESSING APPARATUS, PROCESSING METHOD, AND NON-TRANSITORY STORAGE MEDIUM

(71) Applicant: NEC CORPORATION, Tokyo (JP)

(72) Inventor: Kenta Ishihara, Tokyo (JP)

(73) Assignee: NEC CORPORATION, Tokyo (JP)

(21) Appl. No.: 18/241,789

(22) Filed: Sep. 1, 2023

(30) Foreign Application Priority Data
Sep. 7, 2022 (JP) 2022-141922

(51) Int. Cl. G06Q 10/0631; G06V 20/52

(52) U.S. Cl. CPC G06Q 10/063116; G06Q 10/063114; G06V 20/52

(57) ABSTRACT

The present invention provides a processing apparatus 1 including: a situation information generation unit 10 that, based on a result of image analysis, generates situation information indicating a situation of each of a plurality of processes executed by a plurality of workers; a delayed process extraction unit 20 that extracts a delayed process the progress of which is delayed from target progress from among a plurality of the processes, based on the situation information; an estimation unit 30 that estimates a cause of a delay in the progress of the delayed process, based on the situation information; and an advice information generation unit 40 that, based on the progress of a process other than the delayed process and a cause of a delay in the progress of the delayed process, generates advice information about a method for assigning personnel to a plurality of the processes.

This application is based upon and claims the benefit of priority from Japanese patent application No. 2022-141922, filed on Sep. 7, 2022, the disclosure of which is incorporated herein in its entirety by reference.

### TECHNICAL FIELD

The present invention relates to a processing apparatus, a processing method, and a program.

### BACKGROUND ART

Technologies related to the present invention are disclosed in International Application Publication No. WO 2022/054663 (Patent Document 1), Japanese Patent Application Publication No. 2022-072116 (Patent Document 2), and Japanese Patent Application Publication No. 2021-082137 (Patent Document 3).

Patent Document 1 discloses a technology for comprehensively evaluating skills and the like possessed by workers for each of a plurality of plant facilities, converting the skills and the like into big data, and assigning required worker for each plant facility by using the information. Then, Patent Document 1 discloses, for each work spot, performing adjustment processing of giving an instruction for relocation of a worker from another plant facility for reinforcement when a work ability falls short of a workload. Specifically, Patent Document 1 discloses performing adjustment processing of giving an instruction for relocation for reinforcement, based on a workload and a work ability.

Patent Document 2 discloses a technology for determining a process in which a task is delayed, by using image analysis.

Patent Document 3 discloses a technology for detecting abnormalities such as a sequence error and omission of work.

### DISCLOSURE OF THE INVENTION

Efficiency, workability, and the like are improved by suitably assigning personnel for each of a plurality of processes at a factory, a laboratory, a warehouse, and the like. However, a delay may occur in one of the processes due to some contingency regardless of the type of personnel assignment. Therefore, a technology for suitably reassigning personnel during work is required.

The technology disclosed in Patent Document 1 performs personnel assignment in consideration of a skill of a worker and cannot perform reassignment of personnel in consideration of a situation actually occurring during work. Patent Documents 2 and 3 do not disclose a technology for reassignment of personnel in consideration of a situation actually occurring during work. Such technologies described in Patent Documents 1 to 3 can perform reassignment of personnel without consideration of a situation actually occurring during work but cannot perform reassignment of personnel in consideration of a situation actually occurring during work. Reassignment of personnel without consideration of a situation actually occurring during work is highly likely not to be optimum personnel assignment.

An example of an object of the present invention is to, in view of the aforementioned issues, provide a processing apparatus, a processing method, and a program that resolve the issue of suitably performing reassignment of personnel during work.

According to an aspect of the present invention, a processing apparatus including:
a situation information generation unit that, based on a result of image analysis, generates situation information indicating a situation of each of a plurality of processes executed by a plurality of workers;
a delayed process extraction unit that extracts a delayed process progress of which is delayed from target progress from among a plurality of the processes, based on the situation information;
an estimation unit that estimates a cause of a delay in progress of the delayed process, based on the situation information; and
an advice information generation unit that, based on progress of the process other than the delayed process and a cause of a delay in progress of the delayed process, generates advice information about a method for assigning personnel to a plurality of the processes is provided.

According to an aspect of the present invention, a processing method including, by at least one computer:
based on a result of image analysis, generating situation information indicating a situation of each of a plurality of processes executed by a plurality of workers;
extracting a delayed process progress of which is delayed from target progress from among a plurality of the processes, based on the situation information;
estimating a cause of a delay in progress of the delayed process, based on the situation information; and,
based on progress of the process other than the delayed process and a cause of a delay in progress of the delayed process, generating advice information about a method for assigning personnel to a plurality of the processes is provided.

According to an aspect of the present invention, a program causing a computer to function as:
a situation information generation unit that, based on a result of image analysis, generates situation information indicating a situation of each of a plurality of processes executed by a plurality of workers;
a delayed process extraction unit that extracts a delayed process progress of which is delayed from target progress from among a plurality of the processes, based on the situation information;
an estimation unit that estimates a cause of a delay in progress of the delayed process, based on the situation information; and
an advice information generation unit that, based on progress of the process other than the delayed process and a cause of a delay in progress of the delayed process, generates advice information about a method for assigning personnel to a plurality of the processes is provided.

According to the aspects of the present invention, a processing apparatus, a processing method, and a program that resolve the issue of suitably performing reassignment of personnel during work are provided.

### BRIEF DESCRIPTION OF THE DRAWINGS

The aforementioned object, and other objects, features, and advantages will become more apparent by the following preferred example embodiments and accompanying drawings.

FIG. 1 is a diagram illustrating an example of a functional block diagram of a processing apparatus.

FIG. 2 is a diagram for illustrating an overview of a processing apparatus.

FIG. 3 is a diagram illustrating an example of a hardware configuration of the processing apparatus.

FIG. 4 is a diagram for illustrating an example of a relation between a plurality of processes.

FIG. 5 is a diagram for illustrating another example of a relation between a plurality of processes.

FIG. 6 is a diagram for illustrating a relation between a process and a task.

FIG. 7 is a diagram schematically illustrating an example of situation information.

FIG. 8 is a diagram schematically illustrating another example of situation information.

FIG. 9 is a diagram illustrating an example of a functional block diagram of a situation information generation unit.

FIG. 10 is a diagram schematically illustrating an example of past record information.

FIG. 11 is a diagram for illustrating processing of determining a timing for exchanging personnel assignments.

FIG. 12 is a diagram illustrating examples of a content of advice information.

FIG. 13 is a diagram illustrating an example of a screen output by the processing apparatus.

FIG. 14 is a diagram for illustrating a relation between a process and a line.

FIG. 15 is a diagram illustrating another example of a screen output by the processing apparatus.

FIG. 16 is a flowchart illustrating an example of a flow of processing in the processing apparatus.

### DESCRIPTION OF EMBODIMENTS

Example embodiments of the present invention will be described below by using drawings. Note that in every drawing, similar components are given similar signs, and description thereof is omitted as appropriate.

### First Example Embodiment

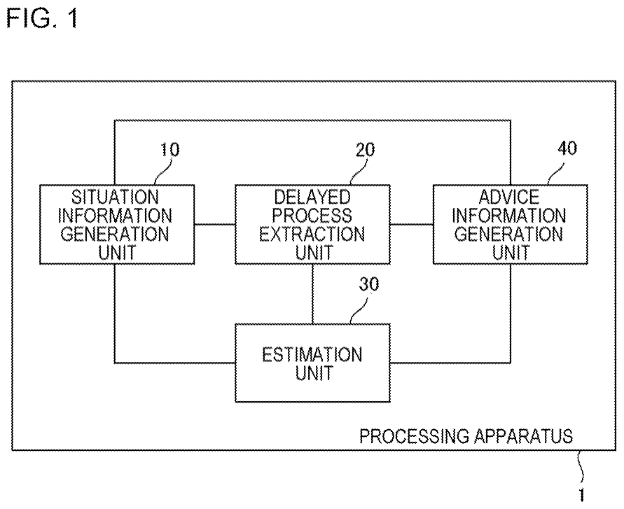

FIG. 1 is a functional block diagram illustrating an overview of a processing apparatus 1 according to a first example embodiment. The processing apparatus 1 includes a situation information generation unit 10, a delayed process extraction unit 20, an estimation unit 30, and an advice information generation unit 40.

Based on a result of image analysis, the situation information generation unit 10 generates situation information indicating a situation of each of a plurality of processes executed by a plurality of workers. The delayed process extraction unit 20 extracts a delayed process the progress of which is delayed from target progress from among a plurality of processes, based on the situation information. The estimation unit 30 estimates the cause of a delay in the progress of the delayed process, based on the situation information. Based on the progress of a process other than the delayed process and the cause of the delay in the progress of the delayed process, the advice information generation unit 40 generates advice information about a method for assigning personnel to a plurality of processes.

The processing apparatus 1 with such a configuration can resolve an issue of suitably performing reassignment of personnel during work.

### Second Example Embodiment

### Overview

A processing apparatus 1 according to the present example embodiment is a tangible form of the processing apparatus 1 according to the first example embodiment.

The processing apparatus 1 has a function of generating and outputting advice information about reassignment of personnel, during work. An overview of processing performed by the processing apparatus 1 is as follows.

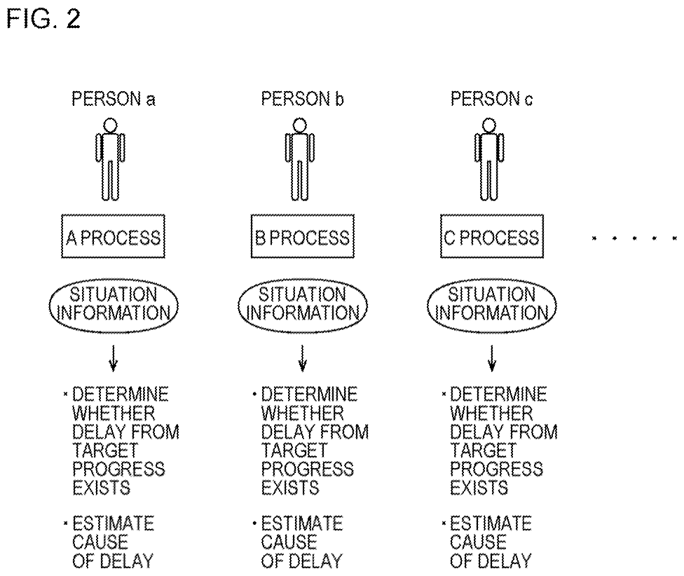

First, for each process, the processing apparatus 1 generates situation information, based on a result of image analysis, as illustrated in FIG. 2. Situation information is information indicating a situation of each process. Then, the processing apparatus 1 determines whether the progress is delayed from target progress for each process, based on situation information of the process. Further, when the progress is delayed from the target progress, the processing apparatus 1 estimates the cause of the delay, based on the situation information. Then, when a process the progress of which is delayed from the target progress exists, the processing apparatus 1 generates and outputs advice information about reassignment of personnel, based on the cause of the delay in the progress of the process and the progress of another process.

Thus, the processing apparatus 1 is characterized by generating advice information about reassignment of personnel, based on characteristic information being “the cause of the delay in the progress of the process” and “the progress of another process.” A configuration of the processing apparatus 1 will be described in detail below.

### Hardware Configuration

Next, an example of a hardware configuration of the processing apparatus 1 will be described. Each functional unit included in the processing apparatus 1 is provided by any combination of hardware and software centered on a central processing unit (CPU), a memory, a program loaded into the memory, a storage unit, such as a hard disk, storing the program [capable of storing not only a program previously stored in the shipping stage of the apparatus but also a program downloaded from a storage medium such as a compact disc (CD) or a server on the Internet], and a network connection interface that are included in any computer. Then, it may be understood by a person skilled in the art that various modifications to the providing method and the apparatus can be made.

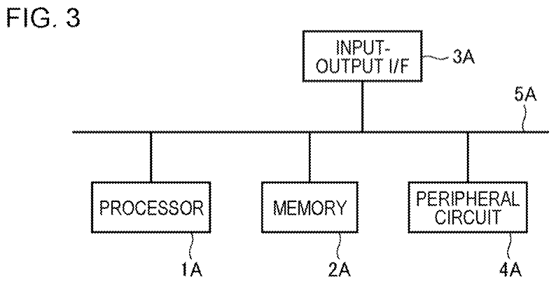

FIG. 3 is a block diagram illustrating a hardware configuration of the processing apparatus 1. The processing apparatus 1 includes a processor 1A, a memory 2A, an input-output interface 3A, a peripheral circuit 4A, and a bus 5A, as illustrated in FIG. 3. Various modules are included in the peripheral circuit 4A. The processing apparatus 1 may not include the peripheral circuit 4A. Note that the processing apparatus 1 may be configured with a plurality of physically and/or logically separate apparatuses. In this case, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from each other. Examples of the processor 1A include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Examples of the input apparatus include a keyboard, a mouse, a microphone, a physical button, and a touch panel. Examples of the output apparatus include a display, a speaker, a printer, and a mailer. The processor 1A issues an instruction to each module and can perform an operation, based on the operation result by the module.

### Functional Configuration

Next, a functional configuration of the processing apparatus 1 according to the present example embodiment will be described in detail. FIG. 1 illustrates an example of a functional block diagram of the processing apparatus 1. As illustrated, the processing apparatus 1 includes a situation information generation unit 10, a delayed process extraction unit 20, an estimation unit 30, and an advice information generation unit 40.

Based on a result of image analysis, the situation information generation unit 10 generates situation information indicating a situation of each of a plurality of processes executed by a plurality of workers.

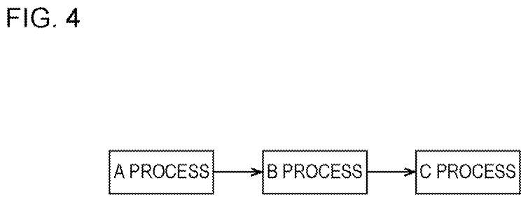

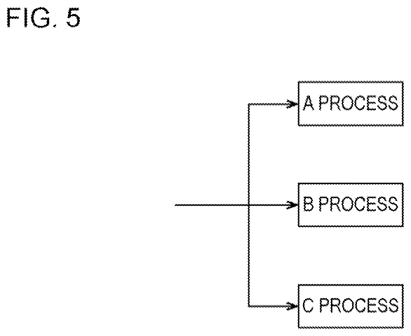

First, a “process” according to the present example embodiment will be described. A plurality of processes are performed on site in the present example embodiment. There are various methods for defining each process, and the method is not particularly limited. Examples of a process include an assembly process of a part X, an inspection process of the part X, a cleaning process of the part X, and a packing process. The plurality of processes may be sequentially executed, as illustrated in FIG. 4. In this case, the progress of a preceding process affects the progress of a succeeding process. Further, each of the plurality of processes may be an independent process, as illustrated in FIG. 5. In this case, the progress of each process does not affect the progress of another process.

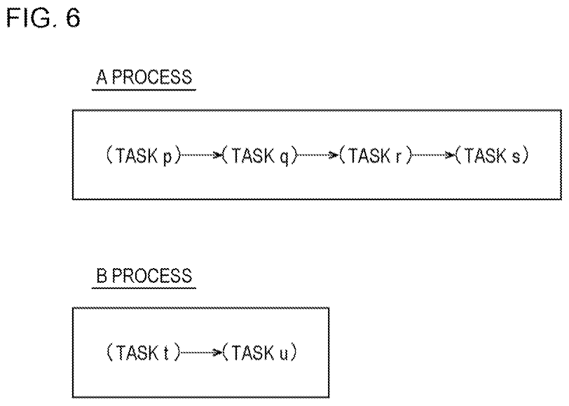

Each process includes one or a plurality of tasks, as illustrated in FIG. 6. For example, a task p, a task q, a task r, and a task s are performed in this order in an A process. Further, a task t and a task u are performed in this order in a B process. There are various methods for defining each task, and the method is not particularly limited. Examples of a task include a task of mounting a part Y on a substrate and a soldering task.

Assignment of personnel is performed on a per-process basis in the present example embodiment. A predetermined number (one or more) of personnel are assigned to each process.

Next, “situation information” will be described. Situation information includes information indicating a progress situation of each process and information indicating a task situation in the process.

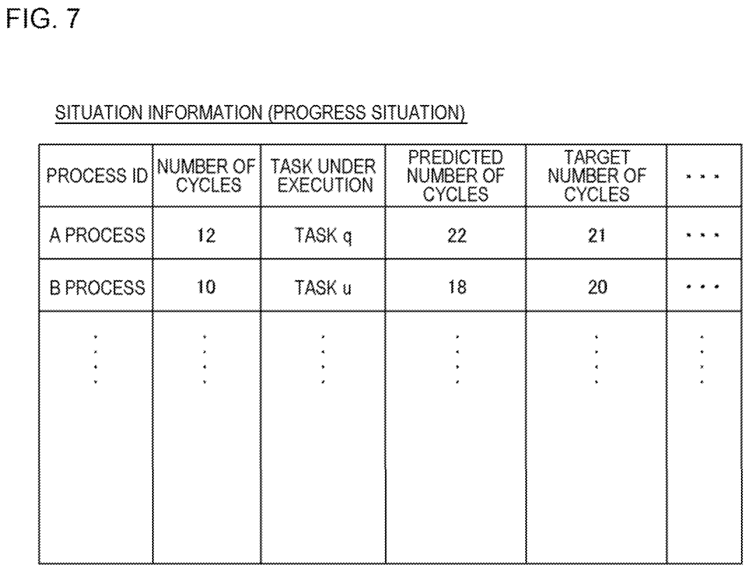

Information indicating a progress situation indicates the progress of each process at that point in time. The progress can be indicated by any information. FIG. 7 illustrates an example of situation information indicating progress. The illustrated information includes a process identifier (ID), the number of cycles, a task under execution, a predicted number of cycles, and a target number of cycles.

A “PROCESS ID” field indicates identification information for distinguishing a plurality of processes from each other.

A “NUMBER OF CYCLES” field indicates the number of executed cycles at that point in time. For example, when a worker in each process repeatedly performs one or a plurality of tasks constituting the process, the number of times the tasks are repeatedly performed is the number of cycles. In the case of the A process illustrated in FIG. 6, the number of cycles increments by 1 every time the task p, the task q, the task r, and the task s are performed once in this order.

A “TASK UNDER EXECUTION” field indicates a task under execution at that point in time. In the case of the A process illustrated in FIG. 6, one of the task p, the task q, the task r, and the task s is a task under execution. Then, FIG. 7 indicates that the task q is under execution.

A “PREDICTED NUMBER OF CYCLES” field indicates a predicted value of the number of cycles to be executed by a closing timing.

A “TARGET NUMBER OF CYCLES” field indicates a target value of the number of cycles to be executed by the closing timing. The value is a predetermined value.

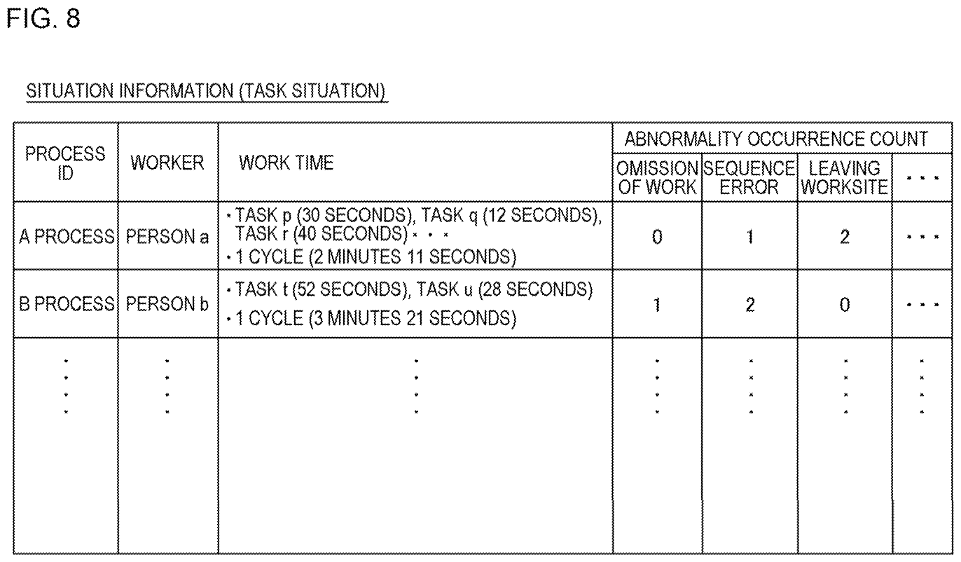

Information indicating a task situation indicates a situation of a task performed up to that point in time. A situation of a task can be indicated by any information. FIG. 8 illustrates an example of situation information indicating a task situation. The illustrated information includes a process ID, a worker, a work time, and an abnormality occurrence count.

A “PROCESS ID” field indicates identification information for distinguishing a plurality of processes from each other.

A “WORKER” field indicates a worker in charge of each process.

A “WORK TIME” field indicates a statistical value (such as a mean value, a maximum value, a minimum value, a median value, or a mode value) of the time required for each task included in each process and a statistical value of the time required for one cycle. The example in FIG. 8 indicates that the time required for the task p in the A process is 30 seconds, the time required for the task q is 12 seconds, the time required for the task r is 40 seconds, and the time required for one cycle is 2 minutes 11 seconds.

An “ABNORMALITY OCCURRENCE COUNT” field indicates the number of times each abnormality has occurred up to then. The example in FIG. 8 indicates that a sequence error has occurred once, and leaving a worksite has occurred twice up to then in the A process.

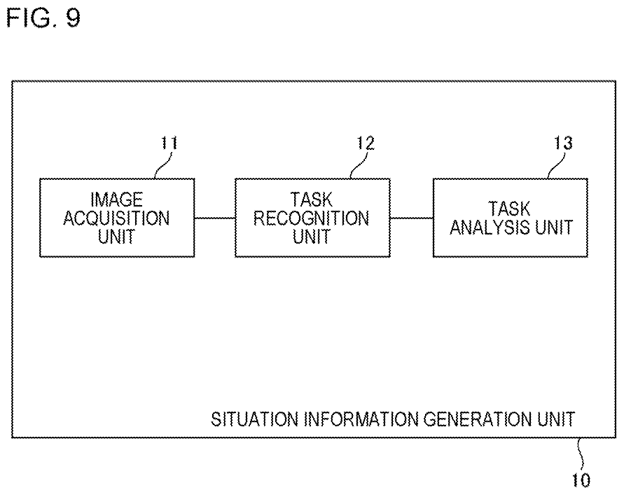

Next, processing of generating situation information as illustrated in FIG. 7 and FIG. 8 will be described. The situation information generation unit 10 includes an image acquisition unit 11, a task recognition unit 12, and a task analysis unit 13, as illustrated in FIG. 9. Generation of situation information is achieved by the functional units.

The image acquisition unit 11 acquires an image. An image of a situation of each process is captured by a camera in the present example embodiment. The image acquisition unit 11 acquires an image generated by the camera in real time. A configuration of real-time acquisition of an image generated by the camera is provided by using any well-known technology.

The camera may be a fixed-point camera fixed at a predetermined position. In addition, the camera may be a wearable camera worn by a worker. In addition, the camera may be a camera equipped on a robot with an autonomous moving mechanism. The camera may continuously capture a dynamic image or may capture a static image at a predetermined timing.

The camera is configured to capture an image of any image capture target indicating a situation of each process. Examples of an image capture target include a worker, an area around a hand of the worker, a work object (such as a part or a product), a tool, and a workbench but are not limited thereto.

The task recognition unit 12 analyzes an image acquired by the image acquisition unit 11 and recognizes a task being performed at a point in time when the image is captured.

For example, a feature of an appearance of a work object, a feature of a workbench, a feature of an area around the work object, a feature of the position of the work object, a feature of an area around a hand of a worker, and a tool being used when each of a plurality of tasks is performed are preregistered. The task recognition unit 12 can recognize a task being performed at a point in time when each image is captured by detecting the features by searching the image.

The task analysis unit 13 generates situation information, based on a recognition result by the task recognition unit 12. Then, the task analysis unit 13 can update the situation information in real time.

For example, the task analysis unit 13 can update the “TASK UNDER EXECUTION” field in the situation information illustrated in FIG. 7, based on a recognition result by the task recognition unit 12. As described above, a task being performed at a point in time when the latest image is captured is recognized by using the recognition result by the task recognition unit 12.

Further, the task analysis unit 13 can increment the number in the “NUMBER OF CYCLES” field in the situation information illustrated in FIG. 7 by 1 every time the last task to be performed out of one or a plurality of tasks performed in each process ends. Note that the number of cycles can be more precisely counted by setting “a plurality of tasks to be previously performed are performed in a predetermined order” as a condition for increment by 1 in addition to “the last task to be performed ends.” As described above, a task being performed at a point in time when the latest image is captured is recognized by using a recognition result by the task recognition unit 12. Based on a history of the recognition result, recognition of a predetermined task being ended or a plurality of predetermined tasks being performed in a predetermined order is achieved.

Further, the task analysis unit 13 can compute the time required for each task in each cycle, based on a recognition result by the task recognition unit 12. Then, by statistically processing the result, the task analysis unit 13 can update the “WORK TIME” field in the situation information illustrated in FIG. 8. As described above, a task being performed at a point in time when the latest image is captured is recognized by using a recognition result by the task recognition unit 12. Based on a history of the recognition result, the starting timing and the ending timing of each task are determined. For example, a timing when the recognition result switches from the task p to the task q is determined as the ending timing of the task p and the starting timing of the task q. Then, the task analysis unit 13 can compute the time between the starting timing and the ending timing of each task as the time required for the task. Further, when each task is executed a plurality of times, the task analysis unit 13 can compute a statistical value (such as a mean value, a maximum value, a minimum value, a median value, or a mode value) of a plurality of work times as a work time for the task. Furthermore, the task analysis unit 13 can compute the time required for one cycle by totaling work times of the tasks.

Furthermore, the task analysis unit 13 can update the “PREDICTED NUMBER OF CYCLES” field in the situation information illustrated in FIG. 7, based on the value of the “WORK TIME” field. An example of the processing will be described below but is not limited thereto.

First, based on the time required for each task indicated by the “WORK TIME” field in the situation information illustrated in FIG. 8 and the remaining work time (the time between the present point in time and the closing timing), the task analysis unit 13 computes the number of cycles that can be executed in the remaining work time.

First, the task analysis unit 13 computes the time required for a cycle under execution at that point in time to end. The cycle under execution ends by completion of the task indicated by “TASK UNDER EXECUTION” and subsequent tasks. For example, when a task under execution in the A process illustrated in FIG. 6 is the task q, the cycle under execution ends by completion of the task q, the task r, and the task s. In this case, for example, the time required for the cycle under execution to end is the total time required for the task q, the task r, and the task s. For example, the time required for each task is the time indicated by the “WORK TIME” field in the situation information illustrated in FIG. 8. Note that a task under execution at that point in time is considered to be in progress to some degree. Therefore, the time required for the task under execution at that point in time may be a time acquired by subtracting any time from the time indicated by the “WORK TIME” field in the situation information illustrated in FIG. 8.

Next, the task analysis unit 13 finds a quotient acquired by dividing a time acquired by subtracting “the time required for the cycle under execution to end” from “the remaining work time (the time between the present point in time and the closing timing)” by “the time required for one cycle”. The task analysis unit 13 previously computes the remaining work time, based on the preregistered closing time. Then, the task analysis unit 13 finds the quotient+1 as the number of cycles that can be executed in the remaining work time. Note that “+1” relates to completion of the cycle under execution. Finally, the task analysis unit 13 can set a value acquired by adding the value of the “NUMBER OF CYCLES” field (the number of cycles executed up to this point) in the situation information illustrated in FIG. 7 and the aforementioned quotient+1 (a predicted value of the number of cycles to be executed in the remaining work time) as the predicted number of cycles.

Further, the task analysis unit 13 can detect occurrence of a predefined abnormality, based on at least one of a recognition result by the task recognition unit 12 and an analysis result of an image acquired by the image acquisition unit 11. Then, the “ABNORMALITY OCCURRENCE COUNT” field in the situation information illustrated in FIG. 8 can be updated based on the detection result.

There are various types of abnormalities, and the type may be defined for each site. Examples of the types of abnormality defined in the present example embodiment include “omission of work,” “a sequence error,” and “leaving a worksite.”

“Omission of work” is an abnormality indicating that a predetermined task in a series of tasks is not performed. For example, while the task p, the task q, the task r and the task s are defined to be performed in this order in the A process as illustrated in FIG. 6, skipping the task q and performing the task p, the task r and the task s in this order cause omission of work. As described above, a task being performed at a point in time when the latest image is captured is recognized by using a recognition result by the task recognition unit 12. Based on a history of the recognition result, omission of work can be detected.

“A sequence error” is an abnormality indicating that the processing order of a series of tasks is different from a predefined order. For example, while the task p, the task q, the task r, and the task s are defined to be performed in this order in the A process as illustrated in FIG. 6, the task p, the task r, the task q, and the task s being performed in this order causes a sequence error. As described above, a task being performed at a point in time when the latest image is captured is recognized by using a recognition result by the task recognition unit 12. Based on a history of the recognition result, a sequence error can be detected.

“Leaving a worksite” is an abnormality indicating that a worker leaves a workplace. The task analysis unit 13 can detect a worker leaving a worksite by image analysis. For example, the task analysis unit 13 may determine that a worker has left a work site when the worker is not detected in a captured image of the worksite.

The situation information generation unit 10 acquires an image generated by the camera in real time while a task is performed, analyzes the image, and generates (updates) situation information.

Returning to FIG. 1, the delayed process extraction unit 20 extracts a delayed process the progress of which is delayed from target progress from among a plurality of processes, based on situation information.

For example, the delayed process extraction unit 20 can extract a process the predicted number of cycles (progress) of which indicated by the situation information in FIG. 7 is less than a reference value (target progress) as a delayed process. The reference value may be a target number of cycles (see FIG. 7) or a value computed based on the target number of cycles (such as the target number of cycles−α).

As another example, the delayed process extraction unit 20 may extract a process the number of cycles (progress) indicated by the situation information in FIG. 7 is less than a reference value (target progress) based on each determination timing as a delayed process. The reference value varies for each determination timing in the example. The reference value increases as the time elapsed from the start of work increases. A table indicating a correspondence between a time elapsed from the start of work and a reference value may be previously prepared, or an arithmetic expression for computing a reference value from a time elapsed from the start of work may be prepared, or another type of information may be prepared. The delayed process extraction unit 20 determines a reference value based on the present point in time (determination timing), based on the aforementioned information.

The estimation unit 30 estimates the cause of a delay in the progress of a delayed process from the target progress, based on situation information.

Each of a plurality of causes is predefined, and a feature appearing in situation information when progress is delayed from the target progress due to the cause is preregistered in the processing apparatus 1. The estimation unit 30 determines the cause of a delay in the progress of a delayed process from the target progress by detecting appearance of the aforementioned predetermined feature in the situation information. Examples of a cause and a feature will be described below.

### Estimation Example 1

When the work time required for a delayed process indicated by situation information is greater than a reference work time and a relation between the work time being required for the delayed process when each of a plurality of other workers executes the process and being indicated by past record information and the reference work time satisfies a predetermined condition, the estimation unit 30 estimates the ability of a worker executing the delayed process at that point in time to be the cause of the delay in the progress of the delayed process from target progress.

The “predetermined condition” is the work time of each of a predetermined number or more of workers or each of workers in a predetermined ratio or greater in the process (delayed process) being less than the reference work time.

Specifically, in the example, when, in spite of the work time (a value indicated by past record information) of each of a predetermined number or more of workers or each of workers in a predetermined ratio or greater in the process (delayed process) being less than the reference work time, the work time of a worker executing the process (delayed process) at that point in time in the process (delayed process) is greater than the reference work time, the estimation unit estimates that the ability of the worker executing the process (delayed process) at that point in time is the cause of the delay in the progress of the process (delayed process) from the target progress.

“The work time required for a delayed process indicated by situation information” being compared with the reference work time in the example may be the time required for each task or the time required for one cycle.

When “the work time required for a delayed process indicated by situation information” being compared with a reference work time is the time required for each task, a reference work time is set for each task. Then, when the work time is greater than a reference work time in “at least one task out of tasks included in each process,” “a predetermined number or more of tasks out of tasks included in each process,” or “tasks in a predetermined ratio or greater in tasks included in each process,” the aforementioned condition of “the work time required for a delayed process indicated by situation information being greater than a reference work time” is satisfied.

On the other hand, when “the work time required for a delayed process indicated by situation information” being compared with a reference work time is the time required for one cycle, the time required for one cycle in each process is set as a reference work time. Then, when the time required for one cycle in each process is greater than the reference work time, the aforementioned condition of “the work time required for a delayed process indicated by situation information being greater than a reference work time” is satisfied.

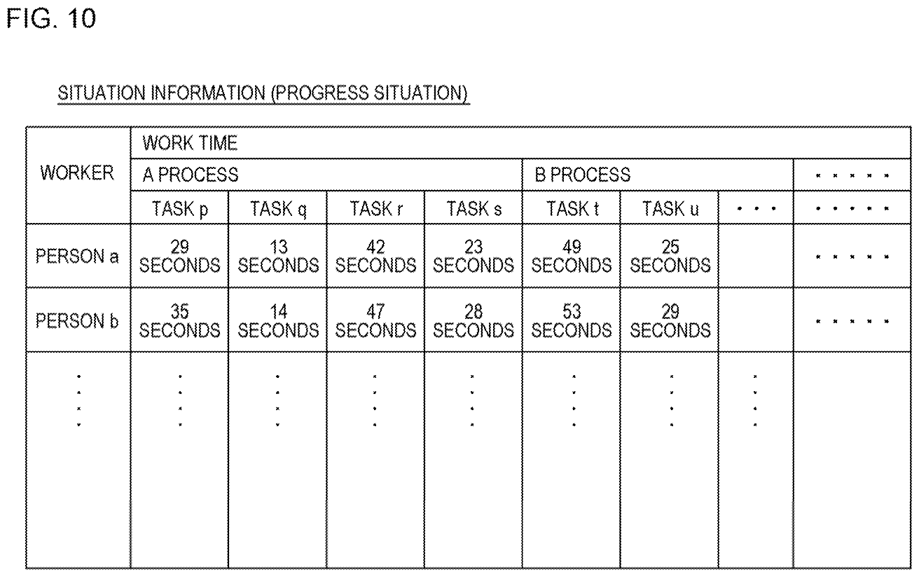

Note that when the example is employed, past record information indicating a record of the time required by each of a plurality of workers for each task is stored in the processing apparatus 1, as illustrated in FIG. 10. The past record information indicates a statistical value (such as a mean value, a maximum value, a minimum value, a median value, or a mode value) of the past record (the time required for each task). The past record information is updated as appropriate, based on situation information generated by the situation information generation unit 10.

### Estimation Example 2

When the work time required for a delayed process indicated by situation information is greater than a reference work time and a relation between the work time being required for the delayed process when each of a plurality of other workers executes the process and being indicated by past record information and the reference work time does not satisfy a predetermined condition, the estimation unit 30 estimates that overestimation of target progress due to underestimation of the reference work time is the cause of the delay in the progress of the delayed process from the target progress.

The “predetermined condition” is the work time of each of a predetermined number or more of workers or each of workers in a predetermined ratio or greater in the process (delayed process) being less than the reference work time.

Specifically, in the example, when the work time of a worker executing the process (delayed process) at that point in time in the process (delayed process) is greater than the reference work time and the work time (a value indicated by past record information) of each of a predetermined number or more of workers or each of workers in a predetermined ratio or greater in the process (delayed process) is greater than the reference work time, the estimation unit 30 estimates that overestimation of target progress due to underestimation of the reference work time in the process (delayed process) is the cause of the delay in the progress of the delayed process from the target progress.

### Estimation Example 3

When situation information indicates occurrence of a predetermined abnormality, the estimation unit 30 estimates that occurrence of the predetermined abnormality is the cause of a delay in the progress of a delayed process from target progress. In addition, when situation information indicates that a predetermined abnormality has occurred a predetermined number of times or more, the estimation unit 30 may estimate that occurrence of the predetermined abnormality is the cause of a delay in the progress in a delayed process from the target progress.

Returning to FIG. 1, the advice information generation unit 40 generates advice information about a method for assigning personnel to a plurality of processes, based on the progress of a process other than a delayed process and the cause of a delay in the progress of the delayed process.

Note that the advice information generation unit 40 may generate advice information when a delayed process is extracted by the delayed process extraction unit 20. Then, the advice information generation unit 40 may not generate advice information when a delayed process is not extracted by the delayed process extraction unit 20.

The advice information generation unit 40 can generate “advice information indicating assistance to the delayed process by a worker in another process” or “advice information indicating exchange of an assignment of a worker to another process for an assignment of a worker to a delayed process.”

### Advice Information Indicating Assistance to Delayed Process by Worker in Another Process

When an accelerated process the progress of which is ahead of target progress by a standard or more exists in processes other than a delayed process, the advice information generation unit 40 generates advice information indicating assistance to the delayed process by a worker in the accelerated process. In the case of assistance, the delayed process is performed by a plurality of workers including a worker in charge of the delayed process up to then and the worker providing assistance.

The aforementioned “standard” is a matter of design. For example, the advice information generation unit 40 can extract a process the predicted number of cycles (progress) of which indicated by the situation information in FIG. 7 is greater than a reference value (target progress) by a standard (a predetermined number such as 5) as an accelerated process.

In the example, the advice information generation unit 40 may determine, based on situation information indicating the situation of the delayed process, a continuation time during which the worker in the accelerated process continues assistance to the delayed process, and generate advice information indicating the determined continuation time.

For example, the advice information generation unit 40 computes the work time required for each task in the delayed process during assistance and then computes the time required for executing a predetermined number of cycles, based on the computed work time. Then, the advice information generation unit 40 determines the computed time required for executing the predetermined number of cycles as the aforementioned continuation time. For example, the work time required for each task in the delayed process during the assistance can be computed in a form of correcting a work time indicated by situation information indicating the situation of the delayed process (see FIG. 8). The work time indicated by the situation information indicating the situation of the delayed process (see FIG. 8) is a record value of the day by a worker in charge of the delayed process up to then. By correction being decreasing the work time according to the assistance, the work time required for each task in the delayed process during the assistance can be computed.

The correction may be subtraction of a previously set subtraction value. Further, the subtraction value may be set according to the worker assisting the delayed process. In this case, the subtraction value may be determined according to a work time [a work time indicated by past record information (see FIG. 10)] when the worker assisting the delayed process performs the delayed process. A greater subtraction value is determined as the work time when the worker assisting the delayed process performs the delayed process becomes shorter.

The aforementioned “predetermined number of cycles” related to determination of a continuation time may be determined by any means. For example, the predetermined number of cycles may be computed based on the difference between a predicted number of cycles and a target number of cycles that are indicated by situation information (see FIG. 7). In this case, a greater predetermined number of cycles is determined as the difference becomes greater.

### Advice Information Indicating Exchange of Assignments of Worker in Another Process and Worker in Delayed Process

When an accelerated process the progress of which is ahead of target progress by a standard or more does not exist in processes other than a delayed process, the advice information generation unit 40 generates advice information indicating exchange of a process of assigning a worker in the delayed process for a process of assigning a worker in one of the processes other than the delayed process. In the case of exchange, a worker in charge of the delayed process up to then performs another process. Then, a worker newly assigned to the delayed process performs the delayed process.

A worker being a target of exchange may be determined by any means. For example, a worker the work time of whom in the delayed process in past record information (see FIG. 10) satisfies a predetermined condition (for example, being equal to or less than a threshold value or being the least among a plurality of workers) may be determined as a target of exchange. In addition, a target of exchange may be randomly determined from among a plurality of workers.

Further, a worker whose work time in the delayed process is not indicated in the past record information (see FIG. 10), that is, a worker without experience in a task in the delayed process may be excluded from targets of exchange. In other words, a worker to be a target of exchange may be determined from among workers whose work times in the delayed process are indicated in the past record information (see FIG. 10), that is, workers with experience in a task in the delayed process.

In addition, a process that can be executed by each worker may be indicated in a database of workers. In this case, a worker to be a target of exchange may be determined from among workers indicated to be able to execute a delayed process in the database.

In the example, the advice information generation unit 40 may determine, based on situation information indicating the situation of the delayed process, a continuation time during which exchange of assignments of workers is continued and generate advice information indicating the determined continuation time.

For example, the advice information generation unit 40 computes the work time required for each task in the delayed process during exchange and then computes the time required for executing a predetermined number of cycles, based on the computed work time.

Then, the advice information generation unit 40 determines the computed time as the aforementioned continuation time. For example, the work time required for each task in the delayed process during the exchange may be set to a work time when the worker performs the delayed process, the work time being indicated by past record information (see FIG. 10).

“The predetermined number of cycles” related to determination of a continuation time may be determined by any means. For example, the predetermined number of cycles may be computed based on the difference between a predicted number of cycles and a target number of cycles that are indicated by situation information (see FIG. 7). In this case, a greater predetermined number of cycles is determined as the difference becomes greater.

When assignments are exchanged, a handover to a next worker is preferably performed at “a convenient timing when a task under execution ends” such as a timing when one cycle ends. In this case, when the timing for exchange of assignments is not suitable, “a convenient timing when a task under execution ends” on one side becomes considerably earlier than “a convenient timing when a task under execution ends” on the other side, thus increasing a waiting time (wasted time) until exchange for a worker on the one side.

In order to eliminate the inconvenience, the advice information generation unit 40 may generate advice information indicating a timing for exchanging assignments, based on the progress of a task currently under execution by each of two workers exchanging assigned processes.

The advice information generation unit 40 predicts an ending timing at which a cycle of each of the processes for which assignments of workers are to be exchanged ends and determines a point in time at which the difference between the ending timings becomes equal to or less than a reference value as a timing for exchanging assignments.

Processing of predicting an ending timing will be described. The advice information generation unit 40 can predict an ending timing, based on a “task under execution” indicated by the situation information in FIG. 7 and a “work time” indicated by the situation information in FIG. 8. First, the advice information generation unit 40 can predict an ending timing of a cycle under execution as follows. Specifically, the advice information generation unit 40 acquires the work time of each task indicated by the situation information in FIG. 8 as the time required for a task executed later than a task under execution. Then, the advice information generation unit determines any value equal to or less than the work time of the task under execution indicated by the situation information in FIG. 8 as the time required for the task under execution. The above is processing assuming that the task under execution is in progress to some degree. For example, the advice information generation unit 40 may compute a predetermined ratio of the work time of the task under execution indicated by the situation information in FIG. 8 as the time required for the task under execution. Then, the advice information generation unit 40 computes the total of the time required for tasks executed later than the task under execution and the time required for the task under execution (the time required for ending the cycle currently under execution) as the time required for ending the cycle under execution. Next, the advice information generation unit 40 computes an ending timing of the cycle under execution, based on the current time and the computed time required for ending the cycle under execution. From then onward, the advice information generation unit 40 computes a point in time after an elapse of a predetermined time (the work time being required for one cycle and being indicated by the situation information in FIG. 8) from the timing as an ending timing for ending the cycle.

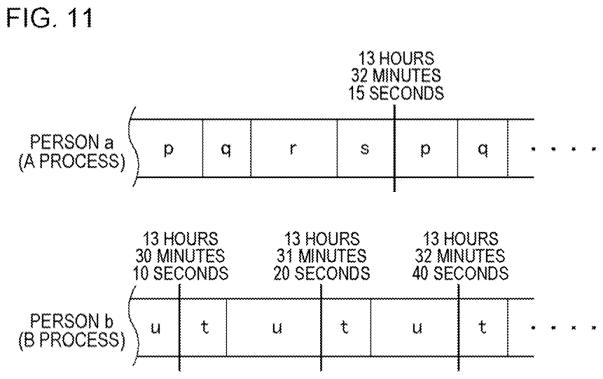

Thus, for example, an ending timing of a cycle of the A process (a timing when the task s ends) and an ending timing of a cycle of the B process (a timing when the task u ends) are computed, as illustrated in FIG. 11. Based on such a computation result, the advice information generation unit 40 determines a point in time (at the earliest timing) when the difference between the ending timings becomes equal to or less than a reference value as a timing for exchanging assignments.

For example, when the reference value is “30 seconds” in the example in FIG. 11, an ending timing of a cycle at 13 hours 32 minutes 15 seconds is an exchange timing in the A process, and an ending timing of a cycle at 13 hours 32 minutes 40 seconds is an exchange timing in the B process. Specifically, a person a ends a task in the A process and starts preparation for exchange at the ending timing of a cycle at 13 hours 32 minutes 15 seconds. Further, a person b ends a task in the B process and starts preparation for exchange at the ending timing of a cycle at 13 hours 32 minutes 40 seconds.

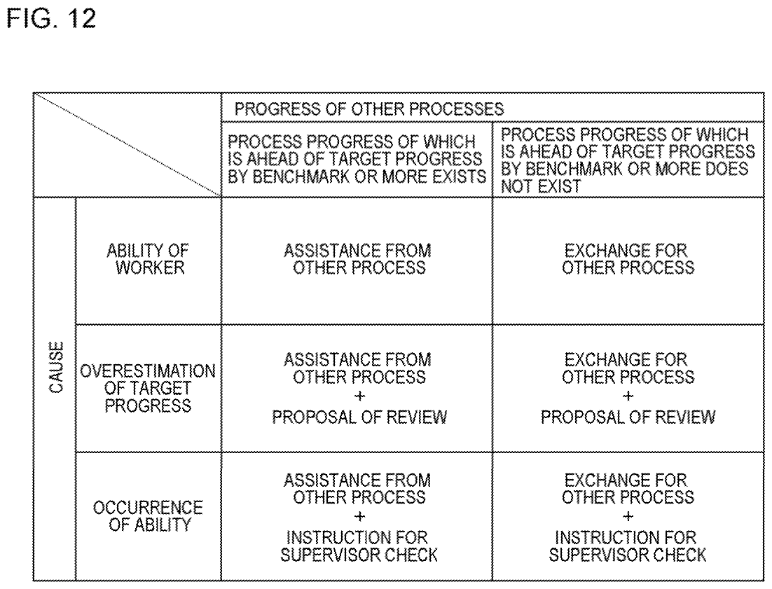

FIG. 12 illustrates a table summarizing examples of advice information generated by the advice information generation unit 40. Note that the examples are strictly examples, and advice information generated by the advice information generation unit 40 is not limited to the examples described in FIG. 12.

The example in FIG. 12 describes contents of various types of advice information generated according to the progress of a process other than a delayed process (“PROGRESS OF OTHER PROCESSES” in the diagram) and the cause of a delay in the progress of the delayed process (“CAUSE” in the diagram).

When an accelerated process the progress of which is ahead of target progress by a standard or more exists in processes other than a delayed process and the cause of the delay is determined to be the ability of a worker in charge of the delayed process, the advice information generation unit 40 generates advice information indicating assistance to the delayed process by a worker in the another process (accelerated process).

Further, when an accelerated process the progress of which is ahead of the target progress by the standard or more exists in processes other than a delayed process and the cause of the delay is determined to be overestimation of the target progress, the advice information generation unit 40 generates advice information indicating assistance to the delayed process by a worker in the another process (accelerated process) and proposing review of the target progress.

Further, when an accelerated process the progress of which is ahead of the target progress by the standard or more exists in processes other than a delayed process and the cause of the delay is determined to be occurrence of an abnormality, the advice information generation unit 40 generates advice information indicating assistance to the delayed process by a worker in the another process (accelerated process) and prompting a supervisor to check the occurring abnormality.

Further, when an accelerated process the progress of which is ahead of the target progress by the standard or more does not exist in processes other than a delayed process and the cause of the delay is determined to be the ability of a worker in charge of the delayed process, the advice information generation unit 40 generates advice information indicating exchange of an assignment of a worker in the delayed process for an assignment of a worker in another process.

Further, when an accelerated process the progress of which is ahead of the target progress by the standard or more does not exist in processes other than a delayed process and the cause of the delay is determined to be overestimation of the target progress, the advice information generation unit 40 generates advice information indicating exchange of an assignment of a worker in the delayed process for an assignment of a worker in another process and proposing review of the target progress.

Further, when an accelerated process the progress of which is ahead of the target progress by the standard or more does not exist in processes other than a delayed process and the cause of the delay is determined to be occurrence of an abnormality, the advice information generation unit 40 generates advice information indicating exchange of an assignment of a worker in the delayed process for an assignment of a worker in another process and prompting a supervisor to check the occurring abnormality.

Generated advice information is output by a predetermined means. For example, advice information is output to a terminal apparatus to be viewed by a supervisor.

Next, an example of a screen output by the processing apparatus 1 will be described.

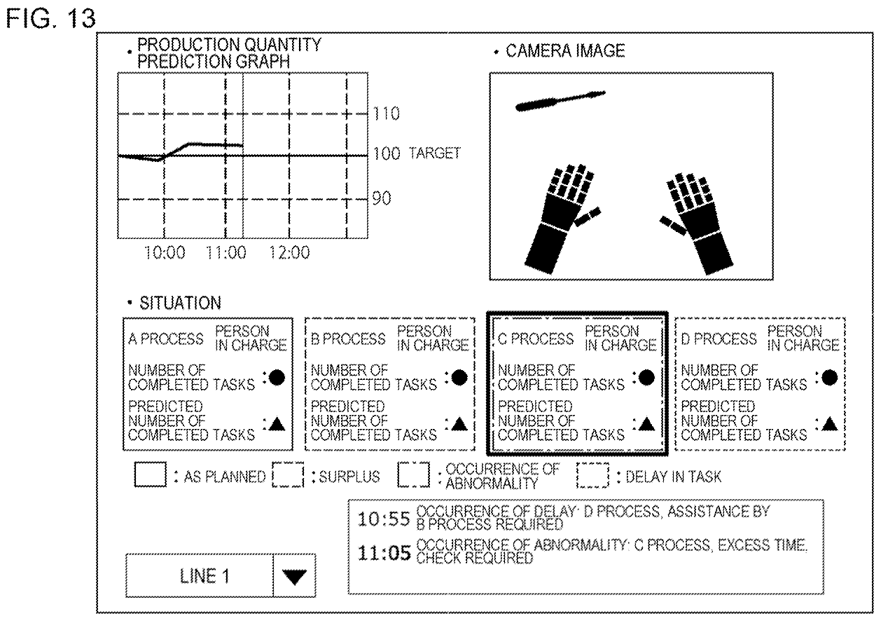

FIG. 13 is an example of a screen output during work. The screen is assumed to be mainly viewed by a supervisor.

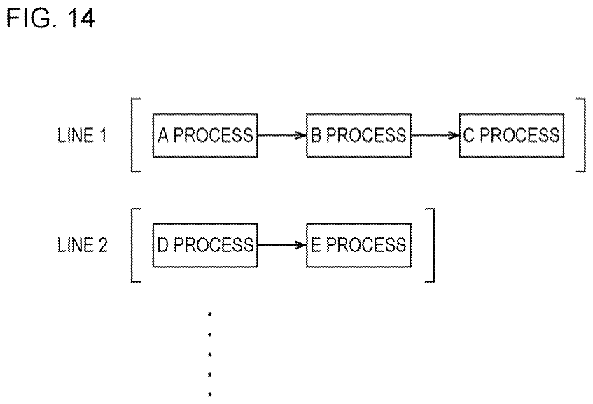

First, a predetermined line can be selected by a pull-down menu at the lower left. A plurality of lines are provided at a site in the example, as illustrated in FIG. 14. Then, each line is composed of one or a plurality of processes.

A “PRODUCTION QUANTITY PREDICTION GRAPH” field illustrates changes in a predicted production quantity of each line at a closing time computed at each timing. A value related to 10 hours is a predicted production quantity at the closing time computed at 10 hours, and a value related to 11 hours is a predicted production quantity at the closing time computed at 11 hours.

A technique for computing a predicted production quantity is not particularly limited, and any technique may be employed. For example, the predicted number of cycles indicated in the aforementioned situation information in FIG. 7 may be a predicted production quantity for each process. Then, when a plurality of processes are sequentially performed as illustrated in FIG. 4, the predicted production quantity in the last process may be computed as a predicted production quantity for each line.

An image acquired by the image acquisition unit 11 is displayed in a “CAMERA IMAGE” field. A live image may be displayed. Note that when image capture is performed by a plurality of cameras in each line, displayed images may be changed by any user input.

A “SITUATION” field indicates situations of one or a plurality of processes included in each line. Display of the “SITUATION” field is achieved based on the aforementioned situation information (see FIGS. 7 and 8). In the illustrated example, for each process, the name of a worker in charge of the process, the number of completed tasks at that point in time (related to the “NUMBER OF CYCLES” field indicated in FIG. 7), and the predicted number of completed tasks at the closing timing computed at that point in time (related to the “PREDICTED NUMBER OF CYCLES” field indicated in FIG. 7). Further, a display of an outline of each process is based on the progress of the process. In the illustrated example, the progress of each process is classified into four categories being “AS PLANNED (the difference between a predicted number of cycles and a target number of cycles is less than a reference value),” “SURPLUS (the predicted number of cycles is greater than the target number of cycles by the reference value or greater),” “OCCURRENCE OF ABNORMALITY (the situation information in FIG. 8 indicates occurrence of an abnormality),” and “DELAY IN TASK (the predicted number of cycles is less than the target number of cycles by the reference value or greater)”.

Advice information generated by the advice information generation unit 40 is displayed in a field at the lower right. As illustrated, the output time of advice information, the content of the advice information, and the cause of the need for assistance or exchange (such as occurrence of a delay in a D process and occurrence of an abnormality in a C process) are displayed in association with each other. Further, advice information may include information indicating the degree of delay in a delayed process requiring assistance or exchange. Examples of the information include the difference between a predicted number of cycles and a target number of cycles that are indicated by the situation information in FIG. 7.

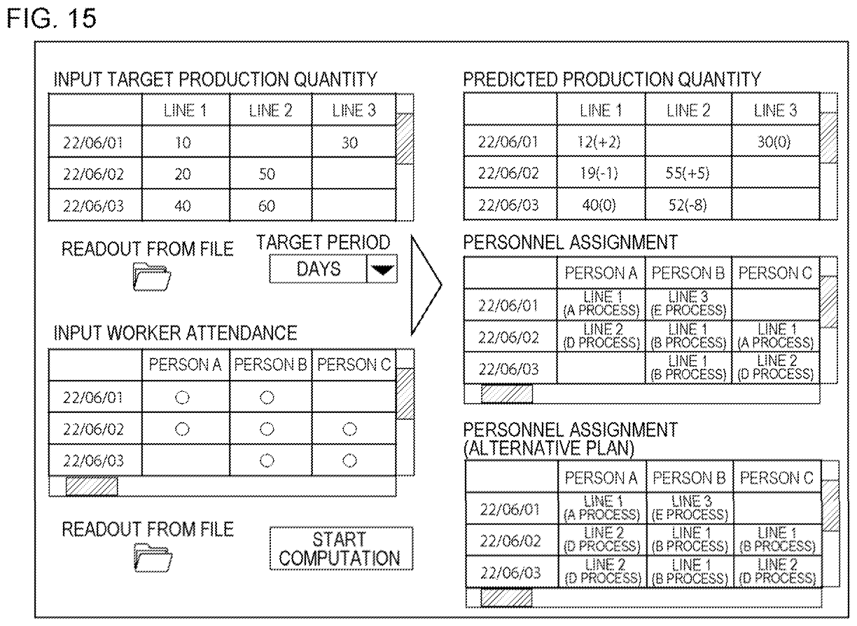

FIG. 15 is an example of a screen output before a start of work. The screen is assumed to be mainly viewed by a supervisor. Personnel assignment before the start of work, target setting of production quantities, and the like are performed through the screen.

A target production quantity of each line is input to an “INPUT TARGET PRODUCTION QUANTITY” field for each workday. The input may be input of a value specifying a cell or readout from a file.

Attendance of each worker is input to an “INPUT WORKER ATTENDANCE” field for each workday. The input may be input of a value specifying a cell or readout from a file.

A process (line) each worker is charged with is input to a “PERSONNEL ASSIGNMENT” field for each workday. A user may specify a cell and input a value. In addition, a computer may determine a process (line) each worker is charged with, based on the value of the “TARGET PRODUCTION QUANTITY INPUT” field and the value of the “INPUT ATTENDANCE OF WORKER” field, and input the determined process (line) to the “PERSONNEL ASSIGNMENT” field.

Determination of a process (line) each worker is charged with by the computer is achieved by employing any well-known technology. For example, a predicted production quantity of each line when each worker is assigned to each process is computed, based on the work time being required for each task for each worker and being indicated by past record information (see FIG. 10). Then, a worker assigned to each line is determined in such a way as to minimize the total value of the difference between the predicted production quantity and a target production quantity of each line.

A “PREDICTED PRODUCTION QUANTITY” field indicates a predicted production quantity of each line for each workday. The computer computes a predicted production quantity of each line when each worker is assigned to each process, based on the value of the “PERSONNEL ASSIGNMENT” field and the work time of each worker required for each task indicated by the past record information (see FIG. 10).

By the information, a user can previously recognize a process in which a delay in the progress may occur. For example, the predicted production quantity of a line 2 relative to the target production quantity on Jun. 3, 2022 is “−8” in the example in FIG. 15. Therefore, the user can recognize the line 2 on Jun. 3, 2022 as a line in which a delay in the progress may occur.

Another plan for personnel assignment is displayed in a “PERSONNEL ASSIGNMENT (ALTERNATIVE PLAN)” field. A personnel assignment (alternative plan) is one of a plurality of personnel assignment plans computed by the computer, based on the value of the “TARGET PRODUCTION QUANTITY INPUT” field and the value of the “INPUT ATTENDANCE OF WORKER” field.

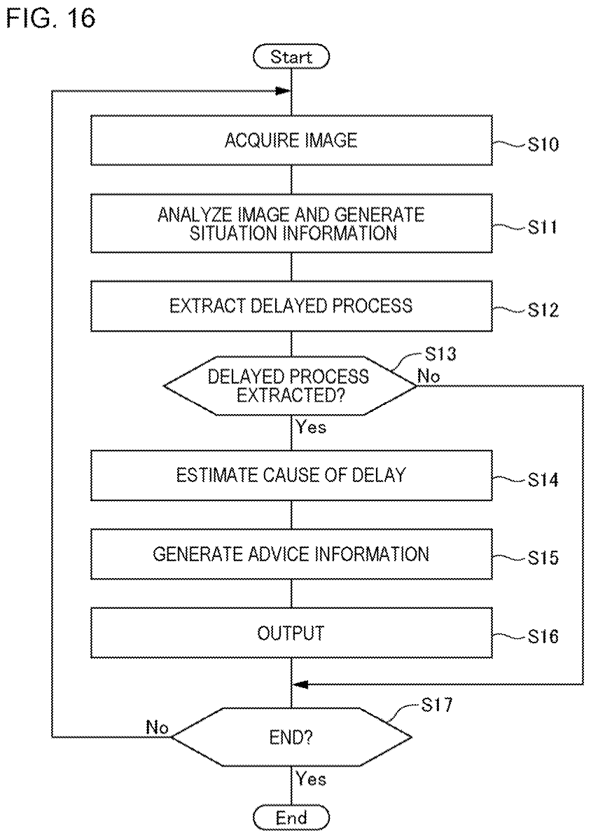

Next, an example of a flow of processing in the processing apparatus 1 will be described by using a flowchart in FIG. 16. FIG. 16 illustrates processing for suitably performing reassignment of personnel during work and is performed during work. For example, an initial personnel assignment is determined through the screen in FIG. 15 or the like before a start of work, and each worker is assigned to each process in accordance with the determination.

First, when acquiring an image indicating a situation of each process (S10), the processing apparatus 1 analyzes the image and generates situation information indicating the situation of the process (S11). For example, the processing apparatus 1 generates situation information indicating a progress situation as illustrated in FIG. 7 and situation information indicating a task situation as illustrated in FIG. 8.

Next, based on the latest situation information generated in S11, the processing apparatus 1 performs processing of extracting a delayed process the progress of which is delayed from target progress from among a plurality of processes (S12).

Then, when a delayed process is extracted in S12 (Yes in S13), the processing apparatus 1 estimates the cause of the delay in the progress of the delayed process, based on the latest situation information generated in S11 (S14). Next, based on the progress of a process other than the delayed process and the cause of the delay in the progress of the delayed process, the processing apparatus 1 generates advice information about a method for assigning personnel to a plurality of processes (S15). For example, the processing apparatus 1 generates advice information as illustrated in FIG. 12.

Then, the processing apparatus 1 outputs the generated advice information (S16). For example, the processing apparatus 1 continuously displays a screen indicating situations of each line and each process as illustrated in FIG. 13. Then, the processing apparatus 1 displays the advice information on the screen (for example, in a field at the lower right). Note that when a delayed process is not extracted in S12 (No in S13), the processing in S14 to S16 is not executed.

### Advantageous Effects

When extracting a delayed process the progress of which is delayed from target progress, the processing apparatus 1 according to the present example embodiment can generate advice information about a method for assigning personnel to a plurality of processes, based on the progress of a process other than the delayed process and the cause of the delay in the progress of the delayed process. Thus, the processing apparatus 1 can generate advice information in consideration of a situation actually occurring during work, and therefore can propose an optimum personnel assignment.

Further, the processing apparatus 1 can generate advice information about a method for assigning personnel to a plurality of processes in consideration of the progress of a process other than a delayed process and therefore can suppress inconvenience of the progress of a process other than the delayed process being greatly delayed due to reassignment of personnel.

Further, the processing apparatus 1 can compute and propose a continuation time during which assistance to personnel or exchange of assignments is performed and therefore can suppress occurrence of inconvenience of the progress of a process other than a delayed process being greatly delayed due to unnecessarily long duration of assistance to personnel or exchange of assignments.

Further, when exchanging assignments of personnel, the processing apparatus 1 can propose an optimum timing for performing exchange and therefore can suppress a wasted time due to one side waiting for the end of a task on the other side when performing exchange.

### Modified Example

Next, a modified example applicable to the aforementioned example embodiment will be described.

For example, advice information according to the aforementioned example embodiment is output to a terminal apparatus to be viewed by a supervisor. As a modified example, advice information may be output to a terminal apparatus to be viewed by a worker. The terminal apparatus to be viewed by a worker may be installed at a workplace of each process. In this case, the processing apparatus 1 may output advice information to a terminal apparatus to be viewed by a worker installed at a process being a target of processing of exchange or reinforcement. Then, the processing apparatus 1 may not output advice information to a terminal apparatus to be viewed by a worker installed at a process not being a target of the processing of exchange or reinforcement.

While the example embodiments of the present invention have been described above with reference to the drawings, the example embodiments are exemplifications of the present invention, and various configurations other than those described above may be employed. The configurations according to the aforementioned example embodiments may be combined or be partially substituted. Further, various changes and modifications may be made to the configurations according to the aforementioned example embodiments without departing from the sprit and scope of the present invention. Further, the configurations and processing disclosed in the aforementioned example embodiments and modified examples thereof may be combined.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments may be combined without contradicting one another.

The whole or part of the example embodiments disclosed above may also be described as, but not limited to, the following supplementary notes.

1. A processing apparatus including:
a situation information generation unit that, based on a result of image analysis, generates situation information indicating a situation of each of a plurality of processes executed by a plurality of workers;
a delayed process extraction unit that extracts a delayed process progress of which is delayed from target progress from among a plurality of the processes, based on the situation information;
an estimation unit that estimates a cause of a delay in progress of the delayed process, based on the situation information; and
an advice information generation unit that, based on progress of the process other than the delayed process and a cause of a delay in progress of the delayed process, generates advice information about a method for assigning personnel to a plurality of the processes.
   2. The processing apparatus according to 1, wherein,
when an accelerated process progress of which is ahead of the target progress by a standard or more exists in one or a plurality of the processes other than the delayed process, the advice information generation unit generates the advice information indicating assistance to the delayed process by a worker in the accelerated process.
   3. The processing apparatus according to 2, wherein
the advice information generation unit determines, based on the situation information indicating a situation of the delayed process, a continuation time during which a worker in the accelerated process continues assistance to the delayed process, and generates the advice information indicating the determined continuation time.
   4. The processing apparatus according to any one of 1 to 3, wherein,
when an accelerated process progress of which is ahead of the target progress by a standard or more does not exist in one or a plurality of the processes other than the delayed process, the advice information generation unit generates the advice information indicating exchange of the process of assigning a worker to the delayed process for the process of assigning a worker to one of the processes other than the delayed process.
   5. The processing apparatus according to 4, wherein
the advice information generation unit generates the advice information indicating a timing for exchanging assignments, based on progress of a task currently under execution by each of two workers the processes assigned to whom are exchanged.
   6. The processing apparatus according to 5, wherein
a worker in the each process repeatedly executes the each process, and
the advice information generation unit predicts an ending timing at which a cycle of each of the processes assignments of workers to which are exchanged ends, and determines a point in time when a difference between the ending timings becomes equal to or less than a reference value as a timing for exchanging assignments.
   7. The processing apparatus according to any one of 4 to 6, wherein
the advice information generation unit determines, based on the situation information indicating a situation of the delayed process, a continuation time during which exchange of assignments of workers is continued, and generates the advice information indicating the determined continuation time.
   8. The processing apparatus according to any one of 1 to 7, wherein,
when a work time being required for the delayed process and being indicated by the situation information is greater than a reference work time and a relation between a work time being required for the delayed process when each of a plurality of other workers executes the delayed process and being indicated by past record information and the reference work time satisfies a predetermined condition, the estimation unit estimates an ability of a worker executing the delayed process at that point in time to be a cause of a delay in progress of the delayed process from the target progress, and
the predetermined condition is a work time of each of a predetermined number or more of workers or each of workers in a predetermined ratio or greater being less than the reference work time.
   9. The processing apparatus according to any one of 1 to 8, wherein,
when a work time being required for the delayed process and being indicated by the situation information is greater than a reference work time and a relation between a work time being required for the delayed process when each of a plurality of other workers executes the delayed process and being indicated by past record information and the reference work time does not satisfy a predetermined condition, the estimation unit estimates overestimation of the target progress due to underestimation of the reference work time to be a cause of a delay in progress of the delayed process from the target progress, and
the predetermined condition is a work time of each of a predetermined number or more of workers or each of workers in a predetermined ratio or greater being less than the reference work time.
   10. The processing apparatus according to any one of 1 to 9, wherein,
when occurrence of a predetermined abnormality is indicated by the situation information, the estimation unit estimates occurrence of the predetermined abnormality to be a cause of a delay in progress of the delayed process from the target progress.
   11. A processing method including, by at least one computer:
based on a result of image analysis, generating situation information indicating a situation of each of a plurality of processes executed by a plurality of workers;
extracting a delayed process progress of which is delayed from target progress from among a plurality of the processes, based on the situation information;
estimating a cause of a delay in progress of the delayed process, based on the situation information; and,
based on progress of the process other than the delayed process and a cause of a delay in progress of the delayed process, generating advice information about a method for assigning personnel to a plurality of the processes.
   12. A program causing a computer to function as:
a situation information generation unit that, based on a result of image analysis, generates situation information indicating a situation of each of a plurality of processes executed by a plurality of workers;
a delayed process extraction unit that extracts a delayed process progress of which is delayed from target progress from among a plurality of the processes, based on the situation information;
an estimation unit that estimates a cause of a delay in progress of the delayed process, based on the situation information; and
an advice information generation unit that, based on progress of the process other than the delayed process and a cause of a delay in progress of the delayed process, generates advice information about a method for assigning personnel to a plurality of the processes.

1. A processing apparatus comprising:
at least one memory configured to store one or more instructions; and
at least one processor configured to execute the one or more instructions to:
generate, based on a result of image analysis, situation information indicating a situation of each of a plurality of processes executed by a plurality of workers;
extract a delayed process progress of which is delayed from target progress from among a plurality of the processes, based on the situation information;
estimate a cause of a delay in progress of the delayed process, based on the situation information; and
generate, based on progress of the process other than the delayed process and a cause of a delay in progress of the delayed process, advice information about a method for assigning personnel to a plurality of the processes.

2. The processing apparatus according to claim 1, wherein the processor is further configured to execute the one or more instructions to:
when an accelerated process progress of which is ahead of the target progress by a standard or more exists, generate the advice information indicating assistance to the delayed process by a worker in the accelerated process.

3. The processing apparatus according to claim 2, wherein the processor is further configured to execute the one or more instructions to:
determine, based on the situation information indicating a situation of the delayed process, a continuation time during which a worker in the accelerated process continues assistance to the delayed process, and generate the advice information indicating the determined continuation time.

4. The processing apparatus according to claim 1, wherein the processor is further configured to execute the one or more instructions to:
when an accelerated process progress of which is ahead of the target progress by a standard or more does not exist, generate the advice information indicating exchange of the process of assigning a worker to the delayed process for the process of assigning a worker to one of the processes other than the delayed process.

5. The processing apparatus according to claim 4, wherein the processor is further configured to execute the one or more instructions to:
generate the advice information indicating a timing for exchanging assignments, based on progress of a task currently under execution by each of two workers the processes assigned to whom are exchanged.

6. The processing apparatus according to claim 5, wherein
a worker in the each process repeatedly executes the each process, and
the processor is further configured to execute the one or more instructions to predict an ending timing at which a cycle of each of the processes assignments of workers to which are exchanged ends, and determine a point in time when a difference between the ending timings becomes equal to or less than a reference value as a timing for exchanging assignments.

7. The processing apparatus according to claim 4, wherein the processor is further configured to execute the one or more instructions to:
determine, based on the situation information indicating a situation of the delayed process, a continuation time during which exchange of assignments of workers is continued, and generate the advice information indicating the determined continuation time.

8. The processing apparatus according to claim 1, wherein the processor is further configured to execute the one or more instructions to:
when a work time being required for the delayed process and being indicated by the situation information is greater than a reference work time and a relation between a work time being required for the delayed process when each of a plurality of other workers executes the delayed process and being indicated by past record information and the reference work time satisfies a predetermined condition, estimate an ability of a worker executing the delayed process at that point in time to be a cause of a delay in progress of the delayed process from the target progress, and
the predetermined condition is a work time of each of a predetermined number or more of workers or each of workers in a predetermined ratio or greater being less than the reference work time.

9. The processing apparatus according to claim 1, wherein the processor is further configured to execute the one or more instructions to:
when a work time being required for the delayed process and being indicated by the situation information is greater than a reference work time and a relation between a work time being required for the delayed process when each of a plurality of other workers executes the delayed process and being indicated by past record information and the reference work time does not satisfy a predetermined condition, estimate overestimation of the target progress due to underestimation of the reference work time to be a cause of a delay in progress of the delayed process from the target progress, and
the predetermined condition is a work time of each of a predetermined number or more of workers or each of workers in a predetermined ratio or greater being less than the reference work time.

10. The processing apparatus according to claim 1, wherein the processor is further configured to execute the one or more instructions to:
when occurrence of a predetermined abnormality is indicated by the situation information, estimate occurrence of the predetermined abnormality to be a cause of a delay in progress of the delayed process from the target progress.

11. A processing method comprising, by at least one computer:
based on a result of image analysis, generating situation information indicating a situation of each of a plurality of processes executed by a plurality of workers;
extracting a delayed process progress of which is delayed from target progress from among a plurality of the processes, based on the situation information;
estimating a cause of a delay in progress of the delayed process, based on the situation information; and,
based on progress of the process other than the delayed process and a cause of a delay in progress of the delayed process, generating advice information about a method for assigning personnel to a plurality of the processes.

12. A non-transitory storage medium storing a program causing a computer to:
generate, based on a result of image analysis, situation information indicating a situation of each of a plurality of processes executed by a plurality of workers;
extract a delayed process progress of which is delayed from target progress from among a plurality of the processes, based on the situation information;
estimate a cause of a delay in progress of the delayed process, based on the situation information; and
generate, based on progress of the process other than the delayed process and a cause of a delay in progress of the delayed process, advice information about a method for assigning personnel to a plurality of the processes.
